(19) United States
(12) Patent Application Publication
(10) Pub. No.: US 2019/0262750 A1
(43) Pub. Date: Aug. 29, 2019

(54) FILTER MEASUREMENTS

(71) Applicant: HEWLETT-PACKARD DEVELOPMENT COMPANY, L.P., Spring, TX (US)

(72) Inventors: Cameron Key, Fort Collins, CO (US); Peter Andrew Seiler, Fort Collins, CO (US); Paul Howard Mazurkiewicz, Fort Collins, CO (US); Thomas Aaron Bondurant, Fort Collins, CO (US)

(73) Assignee: HEWLETT-PACKARD DEVELOPMENT COMPANY, L.P., Spring, TX (US)

(21) Appl. No.: 16/342,450

(22) PCT Filed: Oct. 18, 2016
(86) PCT No.: PCT/US2016/057462

§ 371 Date: Apr. 16, 2019

(51) Int. Cl. B01D 35/143; G01N 15/06; B01D 46/00; B01D 46/44

(52) U.S. Cl. CPC B01D 35/1435; G01N 15/0631; B01D 46/448; B01D 46/446; B01D 46/442; B01D 46/0086

(57) ABSTRACT

In some examples, a filter assembly includes a filter to remove particulates from a fluid flowing through the filter, electrodes attached to the filter, the electrodes spaced apart in a direction that is cross-wise to a direction of a flow of the fluid; and a sensor to measure an electrical characteristic of a space between the electrodes, wherein the measured electrical characteristic varies depending upon an amount of particulates in the space.

### BACKGROUND

Filters can be used in various types of systems to remove or reduce particulates from fluid. For example, a system can use a flow of air to perform convective heat transference. A filter can be placed in the path of an airflow to remove particulates from entering into an inner chamber of the system. In other examples, a filter can be used to remove particulates from a flow of liquid, such as water or other liquids.

### BRIEF DESCRIPTION OF THE DRAWINGS

Some implementations of the present disclosure are described with respect to the following figures.

FIG. 1 is a block diagram of a system that includes a filter and a sensor to detect an amount of particulates accumulated in the filter, according to some examples.

FIG. 2 is a block diagram of a filter assembly according to some examples.

FIG. 3 is a schematic diagram of a filter assembly according to further examples.

FIG. 4 is a block diagram of a computer to interact with a filter assembly according to some examples.

FIG. 5 is a block diagram sensing arrangement according to alternative examples.

FIG. 6 is a block diagram of a sensor according to further examples.

### DETAILED DESCRIPTION

In the present disclosure, the article “a” “an”, or “the” can be used to refer to a singular element, or alternatively to multiple elements unless the context clearly indicates otherwise. Also, the term “includes,” “including,” “comprises,” “comprising,” “have,” or “having” is open ended and specifies the presence of the stated element(s), but does not preclude the presence or addition of other elements.

A filter used in a system to remove particulates from a flow of fluid can become clogged with particulates over time. A fluid can refer to a gas (such as air or another type of gas) or a liquid (such as water or another type of liquid). Examples of systems that can include filters to remove particulates from fluid include a computing system or other type of electronic system, a heating, ventilating, and air conditioning (HVAC) system, manufacturing or other industrial equipment, flow control equipment, an engine of a vehicle, a fluid filtration system, and so forth. Examples of particulates include dust particles in air, debris in liquid, powder used in industrial equipment, shavings from milling or grinding equipment, biological materials (such as hair, skin cells, pollen, and other biological matter shed by plants and animals), and so forth.

As a filter becomes clogged, a flow rate of a fluid flowing through the filter can be reduced, which reduces the effectiveness of the filter. For example, the reduced fluid flow rate caused by a clogged filter can reduce a heat exchange or gas exchange capability of a system. A clogged filter can also reduce the suction force of a fluid intake vent or an expulsion force of a fluid outlet vent. Additionally, the accumulation of particulates by a filter in a system can pose risks to an environment around the system, to humans who are using or in the proximity of the system, and/or to the system itself. Examples of risks to a system caused by particulates include mechanical erosion or failure, chemical corrosion, electrical shorting, failure or damage caused by over-heating, or other risks. Examples of risks to humans in the proximity of the system include electric shock from catastrophic failure of a high voltage system due to over temperature events, exposure of humans to high levels of particulates, and so forth. Techniques that replace or clean filters at regular intervals are not able to detect excessive buildup of particulates at the filters between the intervals. Alternatively, regular intervals may cause undue maintenance to filters that are not yet clogged enough to impact the system, which may incur unnecessary cost of maintenance.

In accordance with some implementations of the present disclosure, a sensor is used to detect presence of particulates accumulated at a filter. In further or alternative examples, the sensor may be used to infer the amount of particulates accumulated in a system in which a certain amount of particulates is expected to enter the system. The sensor measures an electrical characteristic of a space between electrodes that are attached to the filter, where the measured electrical characteristic varies depending upon an amount of particulates in the space. As particulates accumulate at the filter and the space between electrodes is filled by the particulates, the electrical characteristic measured by the sensor can be used to determine an amount of particulates at the filter.

In some examples, the measured electrical characteristic can include an electrical conductivity of the space between electrodes. The electrical conductivity can be represented as an electrical resistance or some other measure of a degree to which a material conducts electricity. The space between the electrodes if free of particulates has a first electrical conductivity. However, as particulates accumulate in the space between the electrodes, the electrical conductivity of the space can change. In examples where the particulates are electrically conductive, then accumulation of particulates in the space would increase the electrical conductivity in the space. In alternative examples, the measured electrical characteristic can include a capacitance between the electrodes that are separated by the space, or an inductance between the electrodes that are separated by the space. In further examples, the measured electrical characteristic can include a combination of electrical characteristics, such as electrical conductivity, inductance, and capacitance.

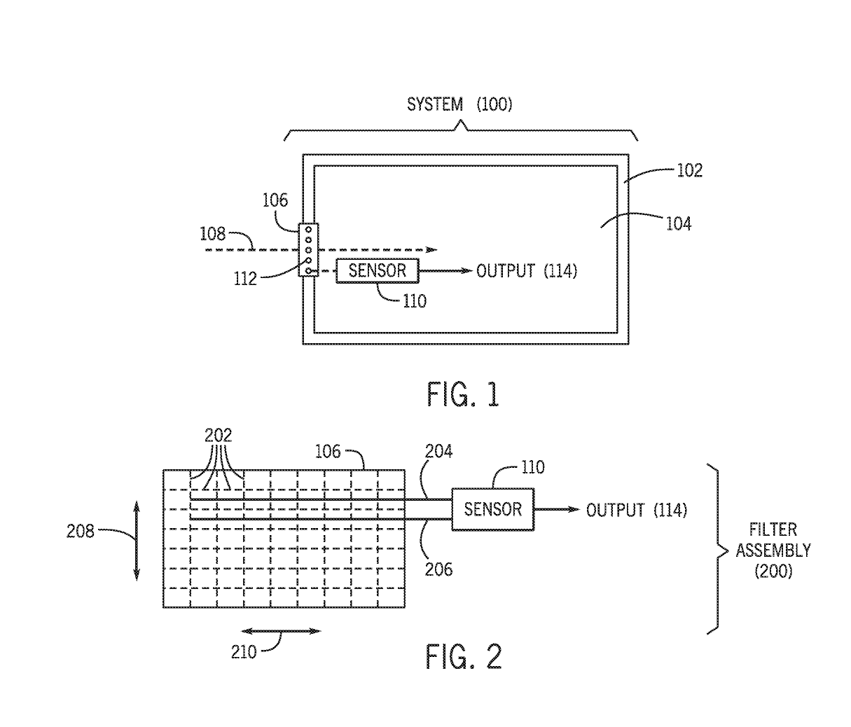

FIG. 1 is a block diagram of an example system 100 that includes a housing 102 that provides an inner chamber 104 defined within the housing 102. Although referred to in the singular sense, the term “housing” can refer to a singular structure, or alternatively, to multiple structures that are attached together.

A filter 106 is provided in an opening of the housing 102. A fluid flows through the filter 106 along a fluid flow path 108. The fluid can flow from outside the inner chamber 104 to inside the inner chamber 104. Although not shown, a fluid flow generator can be provided either upstream or downstream of the filter 106 to produce a flow of the fluid along the fluid flow path 108. In examples where the fluid is an air or another type of gas, the fluid flow generator can include a fan or other type of device to move a gas. In examples where the fluid is a liquid, a fluid flow generator can include a pump or other type of device to move a liquid.

In the arrangement shown in FIG. 1, the filter 106 is provided at a fluid intake of the system 100, where the fluid intake draws the fluid from outside the system to flow into the inner chamber 104 of the system 100. In another arrangement, the filter 106 (or another filter) can be provided at a fluid outlet of the system 100, which expels air from the inner chamber 104 of the system 100 to the outside of the system 100. In a further arrangement, the filter 106 (or another filter) can be provided inside the inner chamber 104 of the system 100 to filter fluid flowing between different portions of the system 100.

The filter 106 is used to remove particulates from the fluid along the fluid flow path 108, such that the filtered fluid that flows into the inner chamber 104 is free of or has a reduced amount of particulates. Although not shown in FIG. 1, an entity may be present in the inner chamber 104, where the entity can be sensitive to the presence of particulates. For example, if the system 100 is a computing system or another type of electronic system, then the entity inside the inner chamber 104 can include a processor or another type of electronic component, which can be damaged by the presence of particulates such as dust, pollen, or other contaminants. As another example, if the system 100 is an HVAC system, then the inner chamber 104 can be an inner room of a house or office building, and the entity that is in the inner chamber 104 can be a human. As yet another example, the system 100 can include equipment such as machinery in a factory, a car engine, a water filtration system, and so forth. In such examples, the entity that is inside the inner chamber 104 can include mechanical parts or surfaces that may be corroded or damaged by the presence of particulates. Although specific examples of systems in which a filter can be used are listed, it is noted that in other examples, filters can be used in other systems.

In accordance with some implementations of the present disclosure, a sensor 110 is provided to detect an amount of particulates that have accumulated at the filter 106. Electrodes 112 are attached to the filter 106, and the electrodes are electrically coupled (by an electrical cable, by an optical cable, or wirelessly) to the sensor 110. The sensor 110 measures an electrical characteristic (such as electrical conductivity, an inductance, or a capacitance) of a space between the electrodes 112 that are attached to the filter, where the measured electrical characteristic varies depending upon an amount of particulates in the space between the electrodes.

The sensor 110 can generate an output 114 based on the measured electrical characteristic. The output 114 can include a value that is based on the measured electrical characteristic. In some examples, the value can be an analog signal. In other examples, the value can be a digitized version of the measured electrical characteristic. Alternatively, the sensor 110 can apply processing of the measured electrical characteristic to produce a value that is output by the sensor 110. As further examples, the output 114 generated by the sensor 110 can be an alert that is produced in response to a comparison of the measured electrical characteristic to a specified threshold. In the latter examples, the sensor 110 can include or be associated with a processor to perform the comparison (the processor can be part of the sensor 110, or the processor can be separate from the sensor 110 but electrically connected to the sensor 110). If the measured electrical characteristic exceeds the specified threshold, then the sensor 110 generates the alert. The measured electrical characteristic exceeding the specified threshold can refer to the measured characteristic being greater than or less than the specified threshold, depending upon the type of measured electrical characteristic.

Although not shown in FIG. 1, the output 114 from the sensor 110 can be provided to a computer, which can be part of the system 100 or which can be located remotely from the system 100. The output 114 can be provided by the sensor 110 on a continual basis, at specified intervals, at the request of an external source, or in response to a specified condition (such as the accumulation of particulates exceeding a specified threshold).

Although reference is made to the filter 106 in the singular sense, it is noted that in further examples, the system 100 can include multiple filters. Also, there can be multiple sensors in the system 100 to measure electrical characteristics of a filter or of multiple filters.

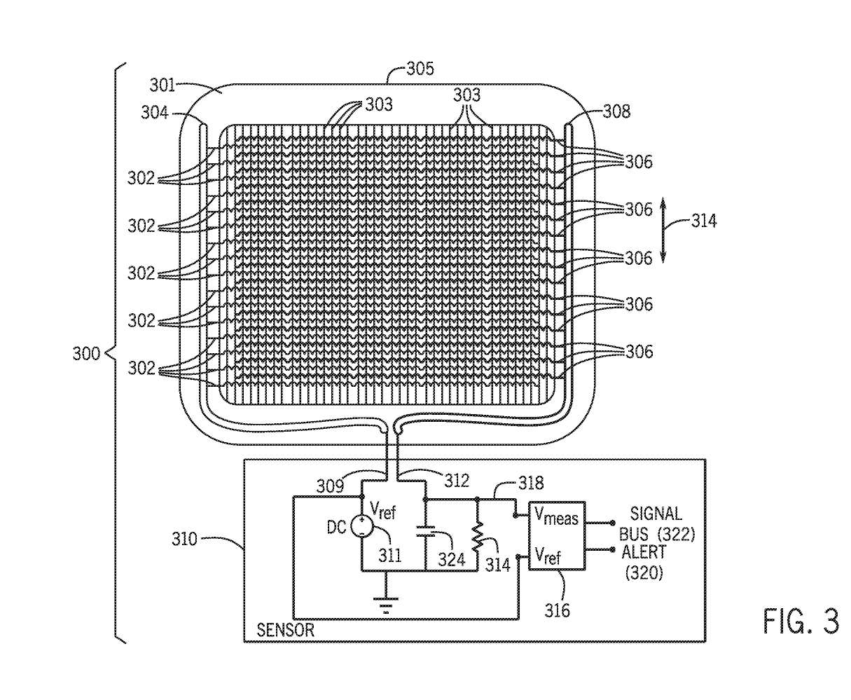

FIG. 2 depicts a filter assembly 200 that includes the filter 106 and the sensor 110. FIG. 2 shows a front view of the filter 106. The filter 106 has filtering structures 202 (shown as a dashed pattern). The filtering structures 202 can be in the form of a mesh with small openings between the filtering structures 202 to allow fluid to pass through but which are able to trap particulates of greater than a specified size, or particulates small enough to be attracted to, and accumulate on the surface of the filtering structures 202. The filtering structures 202 can be part of a layer of a filtering medium, or multiple layers of filtering media.

In FIG. 2, the electrodes 112 of FIG. 1 include an electrode 204 and an electrode 206. The electrodes 204 and 206 can be in the form of electrical conductors that are attached to the filtering structures 202 of the filter 106. The electrodes 204 and 206 are spaced apart along a first axis (represented as 208) of the filter 106, such that a space is provided between the electrodes 204 and 206.

The electrodes 204 and 206 are spaced apart in a direction that is cross-wise to a direction of a fluid flow through the filter 106. A given direction is “cross-wise” to the direction of a fluid flow if the given direction is angled with respect to the direction of the fluid flow. The given direction is angled with respect to the direction of the fluid flow if the given direction has a non-zero angle with respect to the direction of the fluid flow. In some examples, the non-zero angle can be 90°, or can be between 45° and 90°, or can be between 30° and 90°, or can be between 20° and 90°.

Particulates that are trapped by the filter 106 can accumulate in the space between the electrodes 204 and 206 (as well as in other parts of the filter 106). In some examples, the presence of accumulated particulates in the space between the electrodes 204 and 206 changes an electrical characteristic (e.g., electrical conductivity, inductance, or capacitance) between the electrodes 204 and 206. The sensor 110 measures this electrical characteristic between the electrodes 204 and 206, and provides the output 114 based on the measured electrical characteristic.

Although FIG. 2 shows the electrodes 204 and 206 being spaced apart along the axis 208, it is noted that in other examples, the electrodes 204 and 206 can be spaced apart along another axis 210 of the filter 106, where the axis 210 is perpendicular to the axis 208. Alternatively, the electrodes 204 and 206 may be spaced apart along both axes 208 and 210, such as along a diagonal axis, in a circular arrangement, in a rectangular arrangement, etc. The electrodes 204 and 206 may remain at a constant distance from each other over the entire length of the electrodes 204 and 206, or the entire length of the electrodes 204 and 206 that is exposed to particulates, or the distance may increase or decrease at various points along the length of the electrodes 204 and 206. In some examples, the fluid that flows through the filter 106 can be non-electrically conductive. The particulates can be more electrically conductive than the fluid. As a result, the buildup of particulates in the space between the electrodes 204 and 206 causes the electrical conductivity of the space between the electrodes 204 and 206 to increase, which can be detected by the sensor 110.

Although just two electrodes 204 and 206 are shown in FIG. 2, it is noted that in other examples, more than two electrodes can be provided, with each pair of the additional electrodes defining a respective space between the pair of electrodes in which particulates can accumulate. The additional electrodes can also be electrically connected to the sensor 110.

FIG. 3 is a schematic diagram of a filter assembly 300 according to further examples. The filter assembly 300 includes a filter 305 and a sensor 310. The filter 305 is an example of the filter 106 of FIGS. 1 and 2, and the sensor 310 is an example of the sensor 110 depicted in FIGS. 1 and 2.

The filter 305 includes a support frame 301 that supports filtering structures 303. FIG. 3 also shows an interleaved arrangement of electrodes, where the interleaved arrangement of electrodes include reference electrodes 302 that are electrically connected to a reference bus 304, and measurement electrodes 306 that are electrically connected to a measurement bus 308. A “bus” can refer to an electrical conductor. The reference bus 304 is connected to a reference node 309 of the sensor 310. The sensor 310 includes a direct current (DC) voltage source 311, which produces a reference voltage V_{ref} that is connected to the reference bus 304 through the reference node 309. Thus, the reference electrodes 302 are all driven to the reference voltage V_{ref}. The measurement bus 308 is connected to a measurement node 312 of the sensor 310. In other examples, a switch (not shown) can be provided between the voltage source 311 and the reference bus 304. The switch is closed to connect V_{ref} to the reference bus 304 when measurement is to be performed, but can be opened to isolate the voltage source 311 when measurement is not being performed.

Although FIG. 3 shows the voltage source 311 as being part of the sensor 310, in other examples, the voltage source 311 is external of the sensor 310, but the reference voltage V_{ref} output by the external voltage source 311 is connected to the reference node 309 of the sensor 310.

The electrodes 302 and 306 are spaced apart from one another along axis 314 of the filter 305. The electrodes 302 and 306 are electrically isolated from one another. The spaces between the electrodes 302 and 306 span regions where particulates are expected to accumulate due to operation of the filter 305.

In the interleaved arrangement of the electrodes 302 and 306 (referred to as a “filter sensor arrangement”), the reference electrodes 302 are alternately placed with respect to the measurement electrodes 306, such that each respective reference electrode 302 is placed between two adjacent measurement electrodes 306 (the measurement electrodes 306 closest to the respective reference electrode 302 on the two sides of the respective reference electrode 302) along the axis 314, and each respective measurement electrode 306 is placed between two adjacent reference electrodes 302 (the reference electrodes 302 closest to the respective measurement electrode 306 on the two sides of respective measurement electrode 306 along the axis 314.

The interleaved arrangement of electrodes 302 and 306 thus provides electrodes in the following sequence: reference electrode, measurement electrode, reference electrode, measurement electrode, and so forth. The space between a reference electrode 302 and an adjacent measurement electrode 306 can initially be free of particulates, but over time as a result of operation of the filter 305, particulates can accumulate in the space. In the present disclosure, a reference electrode is adjacent a measurement electrode if there is no other electrode that intervenes between the reference electrode and the measurement electrode.

Collectively, the spaces between the reference electrodes 302 and the measurement electrodes 306 make up an overall space whose electrical characteristic can be measured by the sensor 310. For example, if the measured electrical characteristic is resistance, then as particulate buildup occurs in corresponding spaces between the reference electrodes 302 and measurement electrodes 306, the sensor 310 is able to measure the overall resistance of the spaces (i.e., the resistance of the overall space measured by the sensor 310 is the parallel arrangement of resistances in the corresponding spaces). In some examples, the electrodes 302 and 306 may be arranged to measure the series resistance of the overall space measured by the sensor 310, to measure the resistance between individual reference electrodes 302 and individual measurement electrodes 306, to measure the resistance between subsets of the reference electrodes 302 and the measurement electrodes (e.g., using multiplexers, a plurality of busses, etc.), or the like.

The ability to measure the overall resistance (referred to as a “filter space resistance”) of multiple spaces in the filter 305 allows for a more accurate measurement of the amount of buildup of particulates at the filter 305. For example, a greater amount of particulates may accumulate in a first portion of the filter 305 than in a second portion of the filter 305. The measured overall resistance provides an average of the resistance due to particulate accumulation in the first portion and the resistance due to particulate accumulation in the second portion of the filter 305.

In addition to the voltage source 311, the sensor 310 also includes a resistor 314 and a processor 316. The processor 316 includes a first input (referred to as a “Vₘₑₐₛ” input in FIG. 3) to receive a voltage of a node 318, and a second input (referred to as a “V_{ref}” input in FIG. 3) to receive the reference voltage V_{ref} from the voltage source 311. In some examples, the processor 316 can include a comparator to compare a voltage at a node 318 to the reference voltage V_{ref}. If the comparator determines that the voltage at the node 318 exceeds V_{ref}, then the comparator outputs an alert 320, which can be provided to a computer. In another example, the comparator may determine that the voltage at the node 318 exceeds a predetermined voltage, which may be used as a threshold to cause the comparator to output the alert 320.

In further examples, the processor 316 can convert a voltage at the node 318 to a value that represents an electrical conductivity of the overall space between the reference electrodes 302 and measurement electrodes 306. The value can be output over a signal bus 322 to the computer. In other examples, the processor 316 can simply output a value representing the voltage measured at the node 318 over the signal bus 322.

The resistor 314 of the sensor 310 and the filter space resistance of the overall space between the reference electrodes 302 and measurement electrodes 306 form a voltage divider. In other examples, the resistor 314 and the filter space resistance can be part of a bridge circuit, such as a Wheatstone bridge. The node 318 is the node between the filter 314 and the filter space resistance. In examples according to FIG. 3, the node 318 is the same as the node 312. In other examples, an intervening circuit (such as a resistor) can be provided between the nodes 312 and 318. In the example arrangement of FIG. 3, the voltage divider outputs a voltage that is based on an input voltage (in this case V_{ref}) and a ratio of the resistor 314 and the filter space resistance.

The voltage at the node 318 corresponds to an amount of accumulation of particulates at the filter 305. A greater accumulation of particulates at the filter 305 results in a lower filter space resistance, which may lead to a lower voltage at the node 318.

In some examples, the sensor 310 can also include a capacitor 324 connected between the node 318 and a common ground. The capacitor 324 can be used to filter noise signals, such as high-frequency noise signals, from the voltage at the node 318.

Although the sensor 310 has an example arrangement to measure a resistance of the overall space between the electrodes 302 and 306 (that form a filter sensor arrangement) attached to the filter 305, in other examples, the sensor 310 can include circuitry to measure a capacitance or an inductance of the filter sensor arrangement.

Capacitance and inductance can be measured using the sensor described in FIG. 3 with some modifications. The measurement of capacitance and inductance employs a time-varying input signal, as opposed to a DC voltage provided by the DC voltage source 311. This time-varying input signal can include a periodic signal such as a square wave or sine wave, or a non-periodic (within one measurement cycle) pulse signal. The response of the filter sensor arrangement to a time-varying signal (or to multiple time-varying input signals) can be measured with respect to time over some predetermined measurement period. The properties of the resulting waveform(s) are used to determine the inductance and/or capacitance of the overall space between the electrodes 302 and 306 for a respective level of particulate accumulation.

In some examples, a sine wave of known magnitude and phase can be applied in series to ground with any known combination of a resistor (e.g., resistor 314), a capacitor (e.g., the capacitor 324), and an inductor (not shown). The magnitude and phase of the output sine wave response of the circuit described above can be used to determine the impedance of the filter sensor arrangement, where the impedance is based on the combined effects of resistance, capacitance, and inductance of the filter sensor arrangement. The impedance of a capacitor is inversely proportional to the frequency of the applied sine wave multiplied by the capacitance, while the impedance of an inductor is directly proportional to the frequency of the applied sine wave multiplied by the inductance. The effect of the capacitance of the filter sensor arrangement on the impedance of the filter sensor arrangement can be differentiated from the effect of the inductance of the filter sensor arrangement on the impedance of the filter sensor arrangement by applying a further sine wave of a different frequency (or multiple further sine waves of different frequencies), and comparing the corresponding output sine wave response waveforms. The level of particulate accumulation of the filter sensor arrangement can therefore either be correlated to impedance and measured by applying only one sine wave, or, if correlated to capacitance or inductance individually, can be measured by applying two or more sine waves of different frequencies.

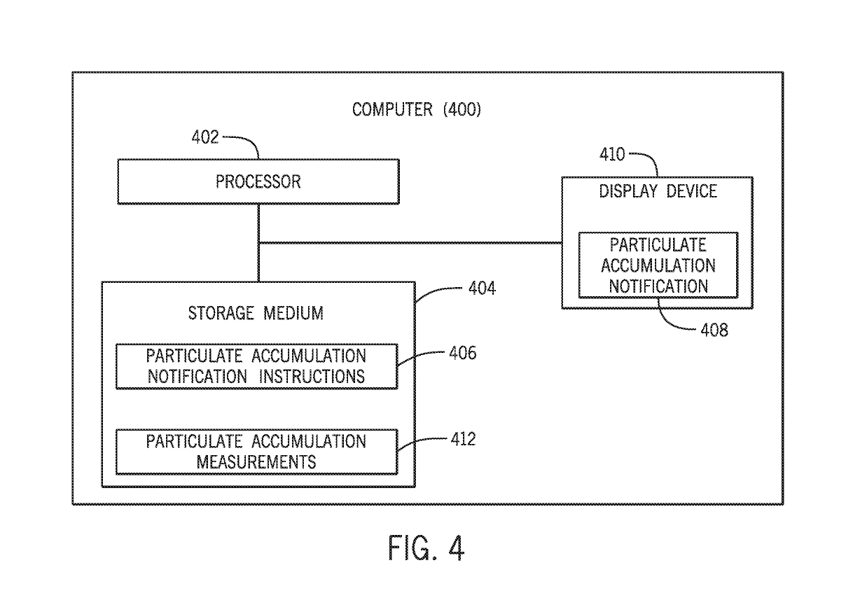

An output from the sensor (110 in FIG. 1 or 2, 310 in FIG. 3) can be communicated to a computer, such as a computer 400 shown in FIG. 4. The computer 400 includes a processor 402 and a non-transitory computer-readable or machine-readable storage medium 404 storing machine-readable instructions, including particulate accumulation notification instructions 406 that are executable on the processor 402.

In response to the output from the sensor 110 or 310, the particulate accumulation notification instructions 406 can make a determination that excessive accumulation of particulates has occurred at the filter 106 or 305, and thus, the filter 106 or 305 should be replaced or cleaned. In some examples, the particulate accumulation notification instructions 406 can cause presentation of a notification (e.g., an audible or visual notification), to a user of the computer 400, which can prompt the user to perform the replacement or cleaning of the filter 106 or 305. A visual notification can include a particulate accumulation notification 408 displayed by a display device 410. For example, the particulate accumulation notification 408 can also provide an indication of the amount of particulate buildup (e.g., 25% buildup, 50% buildup, 75% buildup, 90% buildup, etc.), and can include a message regarding an action to take, e.g., “replace filter.”

In further examples, the particulate accumulation notification instructions 406 can use the output of the sensor 110 or 310 to compute a measure of cleanliness of a system in which the filter 106 or 305 is provided. Based on the amount of particulates accumulated at the filter 106 or 305 determined using the output of the sensor, the particulate accumulation notification instructions 406 can provide an indication (in the particulate accumulation notification 408, for example) of the environmental condition in the system 100. For example, the notification can include a numerical value or score, a graphical element that can be set to different colors, or any other visual indication that can be adjusted to indicate the quality of a system environment.

The particulate accumulation notification instructions 406 can also store particulate accumulation measurements 412 output by the sensor 110 or 310 in the storage medium 304, to provide a historical log of particulate accumulation at the filter 106 or 305.

In some examples, the particulate accumulation notification instructions 406 can also use the measurements output by the sensor 110 or 310 to provide an early warning of detection of hazardous particulates. In an industrial environment, for example, particulates such as tin whiskers or copper shavings or other hazardous particulates can cause malfunctions of electronic components or may be hazardous to humans. If the particulate accumulation notification instructions 406 detect, based on the measurements output by the sensor 110 or 310 that the level of such particulates exceed a threshold, then the particulate accumulation notification instructions 406 can provide a warning to a user. Alternatively, the detection of hazardous particulates may be determined based on a fast rate of change in the particulate accumulation measurements 412, which may be indicated by a rapid change in the resistance or other electrical characteristic measured by the sensor 110 or 310.

The electrical characteristic measured in a space across the electrodes (e.g., across electrodes 204 and 206 in FIG. 2 or across electrodes 302 and 306 in FIG. 3) by the sensor 110 or 310 can be a function not only of particulate accumulation, but also of temperature, barometric pressure, relative humidity and condensation. Therefore, a temperature sensor, a pressure sensor, and/or a humidity sensor can be added to the system, to allow for particulate accumulation to be more accurately inferred from the electrical characteristic measurement.

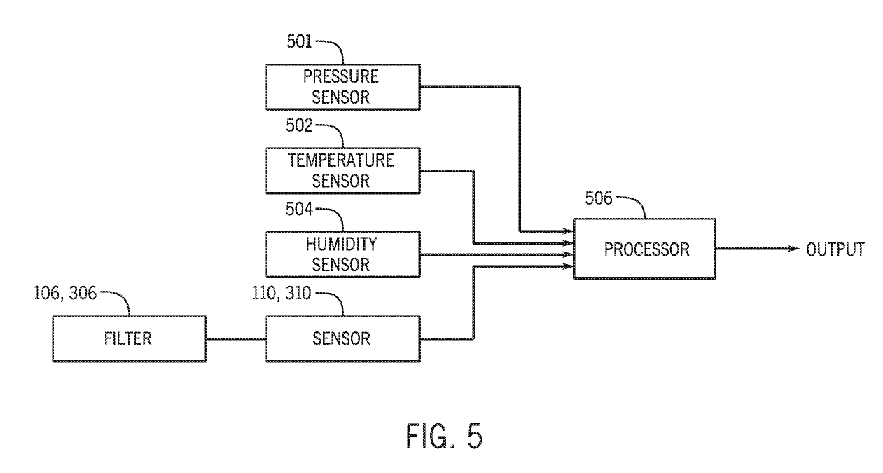

FIG. 5 shows an example arrangement that includes a pressure sensor 501, a temperature sensor 502, and/or a humidity sensor 504, in addition to the sensor 110 or 310 that measures an electrical characteristic of the filter 106 or 305. The temperature sensor 502 can measure a temperature of the filter 106 or 305. Variation in temperature can have an effect on the measured electrical characteristic. For example, the sensor 110 or 310 can behave differently at different temperatures. Such changes in behavior of the sensor 110 or 310 can be determined using a model or empirical data. In further examples, the measured temperature can provide an indication of whether condensation may occur at the filter 106 or 305. For example, if the measured temperature is below a dew point of the environment in which the filter 106 or 305 is provided, then condensation may occur. The condensation can cause water droplets to form in a space between electrodes. The presence of water droplets can cause the electrical resistance of the space to decrease. The contribution of the presence of water droplets to the electrical resistance of the space between the electrodes can be considered by a processor 506, which receives, as an input, the measured temperature from the temperature sensor 502, when determining the amount of particulate buildup at the filter 106 or 305

The processor 506 can access information that correlates temperature to amount of condensation for a given dew point. Given a measured temperature, an amount of condensation can be determined, and this amount of condensation can be used to adjust (e.g., scale) the measured output from the sensor 110 or 310.

The pressure sensor 501 can measure a pressure of an environment around the filter 106 or 305. Condensation can also be dependent on pressure, so that the measured pressure can be used to determine an amount of condensation for a given dew point.

The humidity sensor 504 can measure the relative humidity of an environment in which the filter 106 or 305 is located. The amount of humidity can affect the resistance of a space caused by buildup of particulates in the space. The processor 506 receives as input a humidity measurement from the humidity sensor 504, and uses the humidity measurement to adjust (e.g., scale) the measured output from the sensor 110 or 310. Note also that humidity can affect the dew point, so that the measured humidity can be used to determine the dew point used to determine an amount of condensation based on temperature and/or pressure as noted above.

More generally, the processor 506 receives a measurement from the sensor 110 or 310, and also receives a measurement from any one or some combination of the following: the pressure sensor 501, the temperature sensor 502 and the humidity sensor 504. Based on the measurement from any one or some combination of the pressure sensor 501, the temperature sensor 502, and the humidity sensor 504, the processor 506 adjusts the measurement from the sensor 110 or 310 to provide an output that indicates an amount of particulate accumulation at the filter 106 or 305.

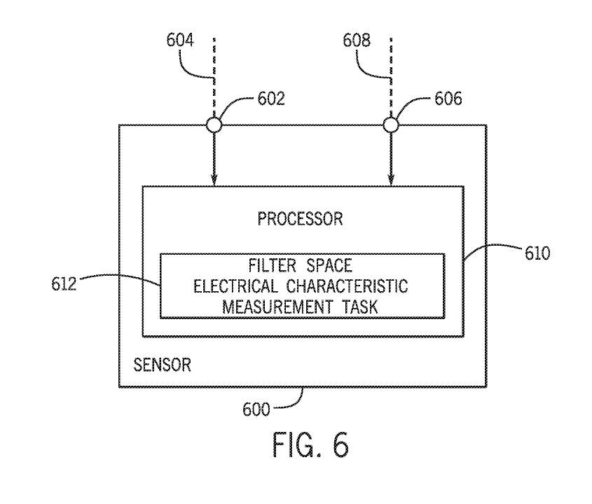

FIG. 6 is a block diagram of an example sensor 600 according to further implementations. The sensor 600 includes a first node 602 to electrically connect to a first electrode 604 that is attached to a filter (e.g., the filter 106 or 305), and a second node 606 to electrically connect to a second electrode 608 that is attached to the filter. The first electrode 604 is spaced apart from the second electrode 608 to provide a space between the first and second electrodes 604 and 608.

The sensor 600 further includes a processor 610 to perform a filter space electrical characteristic measurement task 612, which measures an electrical characteristic of the space between the first and second electrodes 604 and 608, where the measured electrical characteristic varies depending upon an amount of particulates in the space.

Various processors (including the processor 316 of FIG. 3, the processor 402 of FIG. 4, the processor 506 of FIG. 5, and the processor 610 of FIG. 6) can be implemented as a hardware processing circuit. For example, the hardware processing circuit can include an integrated circuit device, a programmable gate array, a microcontroller, a microprocessor, a core of a multi-core microprocessor, and so forth.

Various tasks as described herein can be performed by a hardware processing circuit, such as any of the processors listed above. In other examples, tasks can be performed by a combination of a hardware processing circuit and machine-readable instructions executable on the hardware processing circuit. The machine-readable instructions can be stored in a non-transitory machine-readable or computer-readable storage medium, which can include any or some combination of the following: a dynamic or static random access memory (DRAM or SRAM), an erasable and programmable read-only memory (EPROM), an electrically erasable and programmable read-only memory (EEPROM) and a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A filter assembly, comprising:
a filter to remove particulates from a fluid flowing through the filter;
electrodes attached to the filter, the electrodes spaced apart in a direction that is cross-wise to a direction of a flow of the fluid; and
a sensor to measure an electrical characteristic of a space between the electrodes, wherein the measured electrical characteristic varies depending upon an amount of particulates in the space.

2. The filter assembly of claim 1, wherein the measured electrical characteristic comprises an electrical conductivity of the space between the electrodes.

3. The filter assembly of claim 1, wherein the measured electrical characteristic comprises a capacitance of the space between the electrodes.

4. The filter assembly of claim 1, wherein the measured electrical characteristic comprises an inductance of the space between the electrodes.

5. The filter assembly of claim 1, wherein the electrodes comprise an interleaved arrangement of a plurality of first electrodes and a plurality of second electrodes, wherein in the interleaved arrangement a respective first electrode of the plurality of first electrodes is positioned between adjacent second electrodes of the plurality of second electrodes, and a respective second electrode of the plurality of second electrodes is positioned between adjacent first electrodes of the plurality of first electrodes, and
wherein the measured electrical characteristic is of spaces between respective pairs of first and second electrodes in the interleaved arrangement.

6. The filter assembly of claim 5, further comprising a first bus electrically connected to the plurality of first electrodes, and a second bus electrically connected to the plurality of second electrodes.

7. The filter assembly of claim 6, further comprising a voltage source to drive the first bus to a reference voltage,
wherein the sensor has a measurement input electrically connected to the second bus.

8. The filter assembly of claim 7, wherein the spaces between respective pairs of first and second electrodes in the interleaved arrangement provide an overall resistance, the sensor comprising:
a resistor that forms a voltage divider with the overall resistance; and
a processor to compare a voltage of a node between the resistor and the overall resistance to the reference voltage.

9. The filter assembly of claim 1, wherein the sensor is to generate an alert in response to a comparison of the measured electrical characteristic exceeding a specified threshold.

10. The filter assembly of claim 1, further comprising:
an additional sensor to measure a further characteristic selected from among a temperature, a pressure, and a humidity; and
a processor to output an indication of particulate accumulation at the filter based on the measured further characteristic and the measured electrical characteristic.

11. A system comprising;
a housing comprising an inner chamber;
a filter to remove particulates from a flow of fluid to produce filtered fluid that is passed to the inner chamber;
electrodes attached to the filter; and
a sensor to measure an electrical conductivity of a space between the electrodes, wherein the measured electrical conductivity varies depending upon an amount of particulates in the space.

12. The system of claim 11, wherein the sensor is to generate an output based on the measured electrical conductivity, and to communicate the output to a computer for use in generating a notification regarding particulate accumulation at the filter.

13. The system of claim 11, wherein the filter comprises filtering structures, and the electrodes comprise a plurality of first electrodes attached to the filtering structures, and a plurality of second electrodes attached to the filtering structures, the plurality of first electrodes electrically isolated from the plurality of second electrodes, and the plurality of first electrodes and the plurality of second electrodes arranged in an interleaved arrangement.

14. A sensor for a filter, comprising:
a first node to electrically connect a first electrode attached to the filter that filters particulates from a fluid flowing through the filter;
a second node to electrically connect a second electrode attached to the filter, wherein the second electrode is spaced apart from the first electrode to provide a space between the first and second electrodes; and
a processor to measure an electrical characteristic of the space between the first and second electrodes, wherein the measured electrical characteristic varies depending upon an amount of particulates in the space.

15. The sensor of claim 14, further comprising a resistor that in combination with a resistance of the space forms a voltage divider, wherein a node of the voltage divider between the resistor and the resistance is connected to a measurement input of the processor.
